(19) United States
(12) Patent Application Publication
(10) Pub. No.: US 2004/0069837 A1
(43) Pub. Date: Apr. 15, 2004

(54) Method of manufacturing plate type titanium heat exchanger

(76) Inventors: Akira Fujiyama, Tokyo (JP); Lee Sang Youl, Seoul (KR); Yoshio Nakajima, Tokyo (JP); Tadao Matsu, Tokyo (JP)

Correspondence Address: STAAS & HALSEY LLP, SUITE 700, 1201 NEW YORK AVENUE, N.W., WASHINGTON, DC, 20005, US

(21) Appl. No.: 10/269,877

(22) Filed: Oct. 15, 2002

(51) Int. Cl. B23P 15/26; B23K 31/02; B23K 35/12; B21D 39/06; B21D 53/02; B21D 53/04; B21D 53/06; B21D 53/08; B23K 31/00

(52) U.S. Cl. 228/183; 29/890.054; 29/890.039; 228/245

(57) ABSTRACT

In a method of manufacturing a plate type titanium heat exchanger in which a plurality of titanium herringbone plates are laminated and flow paths are formed between the respective herringbone plates, after brazing materials are charged or coated to the joints between the herringbone plates, respectively, the herringbone plates are placed in a vacuum heating furnace, subjected to vacuum degas processing while being gradually heated, and joined to each other by brazing by being more heated after a prescribed vacuum pressure has been obtained.

### BACKGROUND OF THE INVENTION

1. Field of the Invention

The present invention relates to a method of manufacturing a plate type titanium heat exchanger.

2. Description of the Related Art

There are known plate type titanium heat exchangers arranged such that a plurality of titanium plates, which are strong and light and excellent in ductility and viscosity, are laminated, and flow paths for fluids, which are subjected to heat exchange, are formed between the respective plates.

Conventionally, the air tightness of the plate type titanium heat exchanger is kept using gap constituting members such as gaskets composed of rubber, asbestos, Teflon, and the like, and an anaerobic adhesive, and the like in the gaps between the plates and in the gaps between nipples and the plates. Further, the plate type heat exchanger uses carrying plates and tightening bolts and nuts each composed of a different type of metal from a view point of cost.

Accordingly, there is a possibility that the leakage, and the like of the fluids take place because the gaps are corroded in a relatively short period of time. In particular, when the heat exchanger is used in severe conditions such as in the atmospheres of sea water, high temperature, and the like, the durability of the heat exchanger is greatly deteriorated.

### SUMMARY OF THE INVENTION

An object of the present invention is to provide a method of manufacturing a plate type titanium heat exchanger which is light and durable and can obtain a perfectly sealed state and has no possibility of the exfoliation of brazed joints.

The present invention relates to a method of manufacturing a plate type titanium heat exchanger in which a plurality of titanium herringbone plates are laminated, and a flow path for a first fluid and a flow path for a second fluid are alternately disposed, the method having the steps of coating Ti—Zr brazing materials to the joints between the respective herringbone plates, placing the herringbone plates in a vacuum heating furnace, and gradually heating the herringbone plates and subjecting the herringbone plates to vacuum degas processing, and joining the herringbone plates by brazing by more heating them after a prescribed degree of vacuum has been obtained.

When the vacuum heating furnace is set to a degree of vacuum of 1 Pa or less and heated to 200° C. to 700° C. while being evacuated, the hydrogen, oxygen, nitrogen, carbon, and the like absorbed by the respective herringbone plates are discharged, thereby the oxidation of the respective herringbone plates is prevented as well as the surfaces of the herringbone plates are activated, and the wetting property of the brazing materials is improved thereby.

When the herringbone plates are joined by brazing under a temperature of 840° C. or more while keeping the vacuum pressure, the binder of the gasified brazing materials is discharged without remaining in the respective narrow gaps of the plates, and the melted brazing materials flows even to the narrow gaps by a capillary phenomenon, thereby the brazing can be executed without leakage.

Further, when the degas processing and the joint operation by brazing are executed, the temperature of the herringbone plates can be easily and accurately controlled by being heated in the vacuum heating furnace, thereby a uniform temperature distribution can be obtained in the herringbone plates.

It is also possible to use a titanium containing material having corrosion resistance as the brazing material similarly to the herringbone plates used as a mother material. The titanium containing material may be a Ti—Zr brazing material containing 20 to 40 wt % of Ti and 20 to 40 wt % of Zr, an activated silver-copper brazing material containing titanium dispersed therein, and so on.

The plate type titanium heat exchanger according to the present invention is less likely to be corroded at the gaps thereof even if it is used in sear water and at high temperature, is more excellent in durability, and has higher air tightness than a heat exchanger whose gaps are sealed with gaskets or adhesives and than a heat exchanger having cover plates and herringbone plates joined to each other by bolts and nuts, and further can enjoy lightness and strength which are features of titanium products.

Further, the respective herringbone plates can be prevented from being oxidized because they discharge the various kinds of gasses absorbed thereby as well as the surfaces thereof are activated, thereby the wetting property of the brazing materials is improved and brazing strength is increased.

Further, air is less likely to remain in the narrow gaps between the herringbone plates in the heat exchanger of the present invention than air in a heat exchanger brazed in inert gas. Moreover, since the binder of the gasified brazing materials is discharged without remaining in the above narrow gaps, the melted brazing materials enter the narrow gaps by a capillary phenomenon, thereby brazing is executed without leakage and a perfect seal property can be obtained. As a result, even if there is a pressure difference between the two fluids between which the heat exchange is executed, there is not a possibility that the brazed portions are exfoliated by the flow of a fluid having high pressure to a low pressure side.

According to one aspect of the present invention, the perfect seal property can be kept for a long period of time by improving the durability of the brazed portions.

### BRIEF DESCRIPTION OF THE DRAWINGS

FIG. 1 is an exploded perspective view of a plate type titanium heat exchanger according to an embodiment of the present invention;

FIG. 2 is a side elevational view of the plate type titanium heat exchanger shown in FIG. 1;

FIG. 3 is a bottom plan view of the plate type titanium heat exchanger shown in FIG. 1; and

FIG. 4 is a plan view of a herringbone plate.

### DESCRIPTION OF THE PREFERRED EMBODIMENT

An embodiment of a plate type titanium heat exchanger according to the present invention will be described below in detail with reference to the drawings.

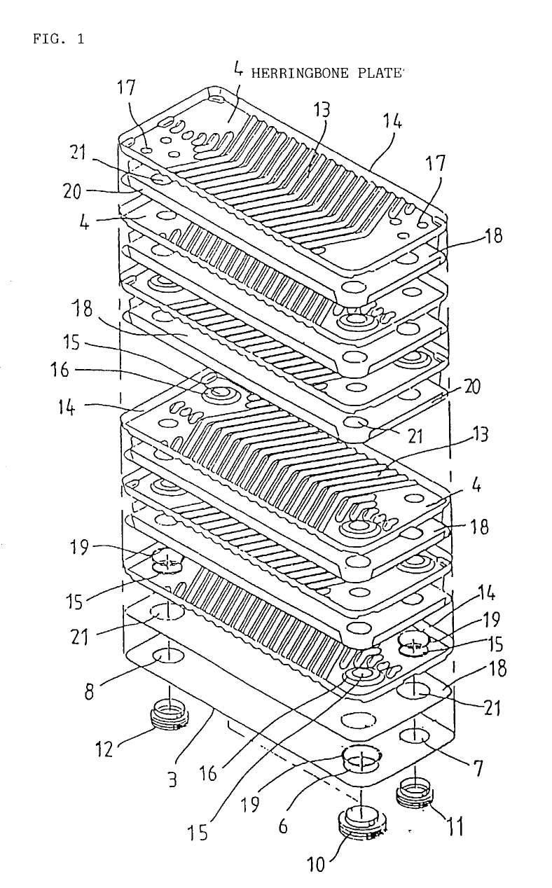

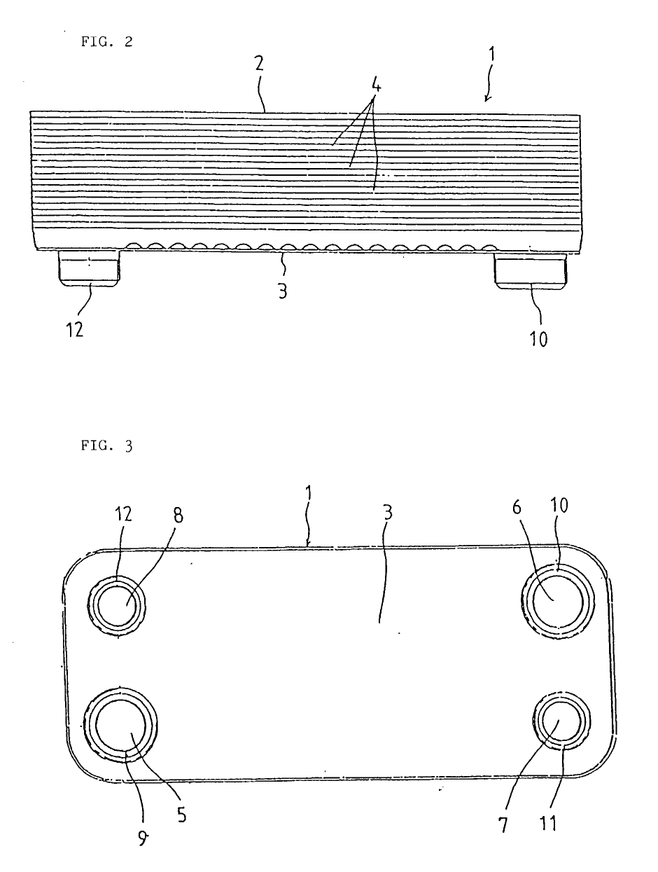

As shown in FIGS. 1 and 2, the plate type titanium heat exchanger 1 is arranged such that a plurality of titanium herringbone plates 4 are laminated between upper and lower titanium cover plates 2 and 3, and further the cover plates 2, 3 and the herringbone plates 4, which overlap up and down, are joined to each other by brazing, and fluid paths for two fluids, which are subjected to heat exchange, are formed between the cover plates 2, 3 and the herringbone plates 4 and between the respective herringbone plates 4.

The upper and lower cover plates 2 and 3 are composed of a flat sheet, and first to fourth through holes 5, 6, 7, and 8, which act as inlet/outlet ports of the two fluids, are drilled through the four corners of the lower cover plate 3, respectively, as shown in FIG. 3.

Then, a first nipple 9 for supplying one of the fluids is coupled with the first through hole 5 0f the lower cover plate 3, and a second nipple 10 for discharging the one of the fluids is coupled with the second through hole 6, which confronts the first through hole 5 on one diagonal line.

Further, a third nipple 11 for supplying the other of the fluids is coupled with the third through hole 7 located at one end of the other diagonal line, and a fourth nipple 12 for discharging the other of the fluids is coupled with the fourth through hole 8, which confronts the third through hole 7.

As shown in FIG. 1, concavo/convex herringbone patterns 13 are formed on each herringbone plate 4 to increase the area thereof 4 as well as to generate turbulence in the fluids flowing through the flow paths. Further, each herringbone plate 4 has an edge wall 14 standing along the peripheral edge thereof, the edge wall 14 being slightly higher than the thickness of the flow paths formed between the herringbone plates 4.

Each herringbone plate 4 has circular holes 15 drilled at the four corners thereof so that the two fluids flow upward and downward therethrough, and cylindrical portions 16 acting as spacers stand around the peripheral edges of the circular holes 15 formed at both the ends of one of diagonal lines.

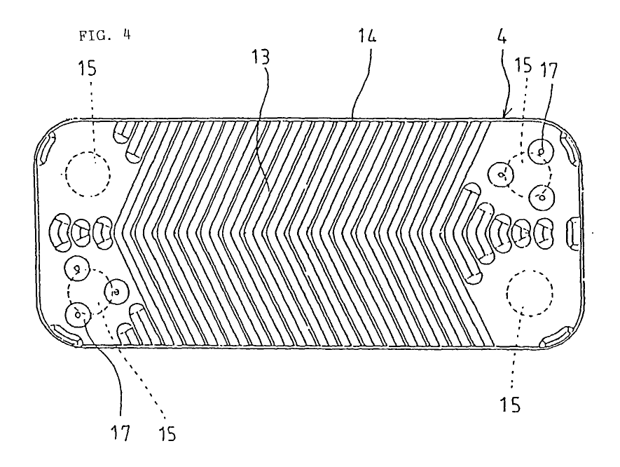

Note that no circular hole 15 is formed in the uppermost herringbone plate 4 as shown in FIG. 4, and three reinforcing projections 17 are formed at both the ends of one of the diagonal lines.

These herringbone plates 4 are laminated vertically in such a manner that the concavo-convex herringbone patterns 13 are alternately inverted, and the cylindrical portions 16 formed around the circular holes 15 alternately confront with each other vertically.

Then, the peripheral edges of the cover plates 2, 3 and the herringbone plates 4, which are disposed vertically, are joined to each other by brazing, and also the extreme ends of cylindrical portions 16 of each herringbone plate 4 are joined to the lower surface of the herringbone plate 4 located thereabove. Accordingly, the flow paths formed between the cover plates 2, 3 and the herringbone plates 4 communicate with each other for every other layer between the plates 4.

Further, the first and second nipples 9 and 10 are brazed to the lower cover plate 3, and the third and fourth nipples 11 and 12 are brazed to the lowermost herringbone plate 4.

Then, the circular holes 15, which have the cylindrical portions 16, of the lowermost herringbone plate 4 are disposed just above the first and second through holes 5 and 6 with which the first and second nipples 9 and 10 are coupled, and the circular holes 15, which have no cylindrical portion 16, of the lowermost herringbone plate 4 are disposed just above the third and fourth through hole 7 and 8 with which the third and fourth nipples 11 and 12 are coupled.

Accordingly, one of the fluids flows into the plate type titanium heat exchanger 1 through the first nipple 9 and the first through hole 5, reaches the uppermost stage of one of the fluid flow paths by the pressure thereof without entering the other fluid flow path by being interrupted by the cylindrical portions 16, flows downward through the flow path communicating for every other layer between the plates 4, and is discharged to the outside of the plate type titanium heat exchanger 1 from the second nipple 10 and the second through hole 6.

Further, the other of the fluids flows into the plate type titanium heat exchanger through the third nipple 11 and the third through hole 7, reaches the uppermost stage of the other fluid flow path without entering the one of the fluid flow paths likewise, flows downward through the flow path communicating for every other layer between the plates 4, and is discharged to the outside of the plate type titanium heat exchanger 3 from the fourth nipple 12 and the fourth through hole 8.

Then, the heat of one of the fluids is effectively exchanged with the heat of the other fluid during the above operation.

The plate type titanium heat exchanger 1 will be manufactured as described below.

An assembled body of the heat exchanger 1 is formed by laminating a lower cover plate 3, a plurality of herringbone plates 4 and an upper cover plate 2 by applying between the plates a paste-like Ti—Zr brazing material containing 20 to 40 wt % of Ti and 20 to 40 wt % of Zr or by interposing between the plates filler plates 18 containing titanium, and further by applying the foregoing paste-like Ti—Zr brazing material between the first and second nipples 9 and 10 and the lower cover plate 3 and between the third and fourth nipples 11 and 12 and the lowermost herringbone plate 4 or by interposing circular fillers 19 between the first and second nipples 9 and 10 and the lower cover plate 3 and between the third and fourth nipples 11 and 12 and the lowermost herringbone plate 4.

Note that standing walls 20 are formed in the filler plates 18 around the peripheral edges thereof except the filler plates 18 to which the flat lower cover plate 3 is brazed so that the edge walls 14 of the herringbone plates 4 can be easily joined to the filler plates 18, and circular cut portions 21 are formed in the respective filler plates 18 at the positions of the four corners thereof corresponding to the circular holes 15.

Further, filler plates 18 can be formed by plate-like reticulate member made of a brazing material, which is arranged only in the joint portion of the herringbone plate 4.

Next, the assembled body of the heat exchanger is placed in a vacuum heating furnace and subjected to vacuum degas processing by being gradually heated while evacuating the furnace by a vacuum pump.

When a prescribed period of time passes while setting the degree of vacuum of the vacuum heating furnace to 1 Pa or less and heating the assembled body of the heat exchanger to 200° C. to 700° C., the hydrogen, oxygen, nitrogen, carbon, and the like absorbed by the cover plates 2, 3 and the herringbone plates 4 are discharged so that the oxidation of the cover plates 2, 3 and the herringbone plates 4 is prevented and the surfaces thereof are activated, and the wetting property of the brazing materials is improved thereby.

Next, when the temperature of the vacuum heating furnace is more increased while keeping the above vacuum pressure, the filler plates 18, the circular filler plates 19, and the brazing material of the coated paste are melted under a temperature equal to or less than 880° C., thereby the cover plates 2 and 3, the herringbone plates 4, and the first to fourth nipples 9, 10, 11, and 12 are joined by brazing.

What is claimed is:

1. A method of manufacturing a plate type titanium heat exchanger in which a plurality of titanium herringbone plates are laminated, a flow path for a first fluid and a flow path for a second fluid are alternately disposed, and both the fluids are subjected to heat exchange on the surfaces of the herringbone plates, comprising the steps of:
coating Ti—Zr brazing materials to the joints between the respective herringbone plates, and then placing the herringbone plates in a vacuum heating furnace, and gradually heating the herringbone plates and subjecting the herringbone plates to vacuum degas processing at the same time; and
joining the herringbone plates by brazing by further heating herringbone plates after a prescribed degree of vacuum has been obtained.

2. A method of manufacturing a plate type titanium heat exchanger according to claim 1, wherein the joint operation by brazing is executed under a vacuum pressure having a degree of vacuum of 1 Pa or less.

3. A method of manufacturing a plate type titanium heat exchanger according to claim 1 or 2, wherein the joint operation by brazing is executed under a temperature of 880° C. or less.

4. A method of manufacturing a plate type titanium heat exchanger according to any of claims 1 to 3, wherein a Ti—Zr brazing material as a titanium containing member containing 20 to 40 wt % of Ti and 20 to 40 wt % of Zr is used as the brazing material.
